(19) United States
(12) Patent Application Publication
(10) Pub. No.: US 2019/0227566 A1
(43) Pub. Date: Jul. 25, 2019

(54) SELF-PROPELLED VACUUM CLEANER

(71) Applicant: Toshiba Lifestyle Products & Services Corporation, Kawasaki-shi (JP)

(72) Inventors: Yuuki Marutani, Nagakute (JP); Junichi Sugimoto, Toyota (JP); Kota Watanabe, Owariasahi (JP); Kyungpyo Hong, Owariasahi (JP); Masaya Kanayama, Tsushima (JP)

(73) Assignee: Toshiba Lifestyle Products & Services Corporation, Kawasaki-shi (JP)

(21) Appl. No.: 16/251,925

(22) Filed: Jan. 18, 2019

(30) Foreign Application Priority Data
Jan. 22, 2018 (JP) 2018-008298

(51) Int. Cl. G05D 1/02; A47L 11/40

(52) U.S. Cl. CPC G05D 1/0251; A47L 11/4011; A47L 2201/04; G05D 2201/0215; G05D 1/0274

(57) ABSTRACT

A self-propelled vacuum cleaner 11 has a main casing 20, driving wheels 21, a travel control part 61, cameras 51, a suction port 31, and an electric cleaning unit 23. The driving wheels 21 are used to make the main casing 20 travel. The travel control part 61 controls the operation of the driving wheels 21. The cameras 51 capture the images of the forward area of the main casing 20. The suction port 31 is disposed in the lower part of the main casing 20. The electric cleaning unit 23 collects dust and dirt through the suction port 31. The suction port 31 is disposed in the main casing 20 at a position adjacent to image ranges CA of the cameras 51.

### CROSS-REFERENCE TO RELATED APPLICATION

This application is based upon and claims the benefit of priority from Japanese Patent Application No. 2018-8298, filed Jan. 22, 2018; the entire contents of which are incorporated herein by reference.

### FIELD

Embodiments described herein relate generally to a self-propelled vacuum cleaner including a camera for capturing an image of the forward area of the main body thereof.

### BACKGROUND

Conventionally, a so-called autonomously-traveling-type vacuum cleaner (cleaning robot) has been known, which cleans a floor surface as a cleaning-object surface while autonomously traveling on the floor surface. Some recent vacuum cleaners of this type include, for example, a camera for capturing an image of the forward area thereof, and detect an object existing in the forward area and the movement thereof on the basis of the image captured by the camera.

On the other hand, the image captured by the camera is mainly used for traveling control of the vacuum cleaner, and the relation with the cleaning part of the vacuum cleaner is not taken into consideration.

### BRIEF DESCRIPTION OF THE DRAWINGS

FIG. 1A is a side view schematically illustrating a self-propelled vacuum cleaner of one embodiment, and FIG. 1B is a plan view schematically illustrating the self-propelled vacuum cleaner viewed from below;

FIG. 2 is a block diagram illustrating the internal configuration of the self-propelled vacuum cleaner;

FIG. 3 is an explanatory view schematically illustrating a vacuum cleaning system including the vacuum cleaner;

FIG. 4 is a side view schematically illustrating the case where an obstacle is detected immediately in front of the self-propelled vacuum cleaner;

FIG. 5 is a side view schematically illustrating the case where the type of the cleaning-object surface immediately in front of the self-propelled vacuum cleaner is carpet;

FIG. 6 is a side view schematically illustrating the case where an object to be removed is detected on the cleaning-object surface immediately in front of the self-propelled vacuum cleaner;

FIG. 7 is a plan view schematically illustrating traveling behavior of the self-propelled vacuum cleaner in the case of detecting an object to be removed on the cleaning-object surface immediately in front of the self-propelled vacuum cleaner;

FIG. 8 is an explanatory view schematically illustrating one example of the method of registering an object not to be removed on an external device in the vacuum cleaning system;

FIG. 9 is a plan view schematically illustrating traveling behavior of the self-propelled vacuum cleaner in the case of detecting an object not to be removed on the cleaning-object surface immediately in front of the self-propelled vacuum cleaner; and

FIG. 10 is a flowchart indicating control of the self-propelled vacuum cleaner.

### DETAILED DESCRIPTION

A self-propelled vacuum cleaner according to an embodiment includes a main body, a travel driving part, a travel control part, a camera, a dust-collecting port, and an electric cleaning unit. The travel driving part is used to make the main body travel. The travel control part controls the operation of the travel driving part. The camera captures images of the forward area of the main body. The dust-collecting port is disposed in the lower part of the main body. The electric cleaning unit collects dust and dirt through the dust-collecting port. The dust-collecting port is disposed in the main body at a position adjacent to the image range of the camera.

A configuration of one embodiment is described below with reference to the drawings.

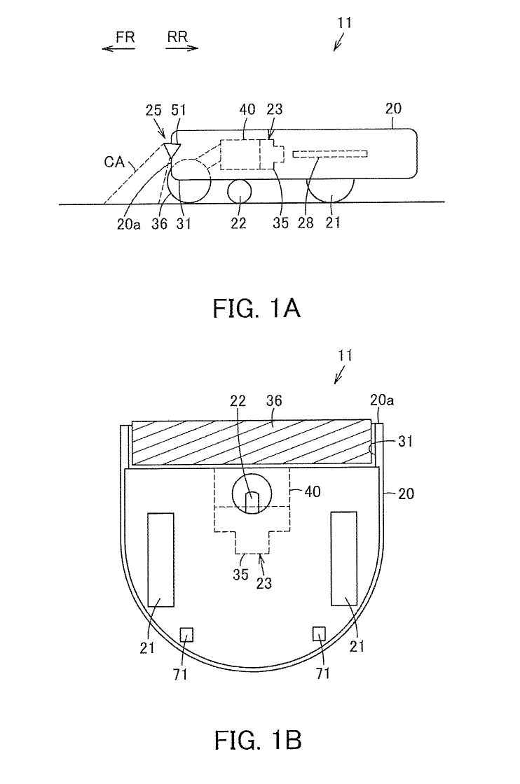

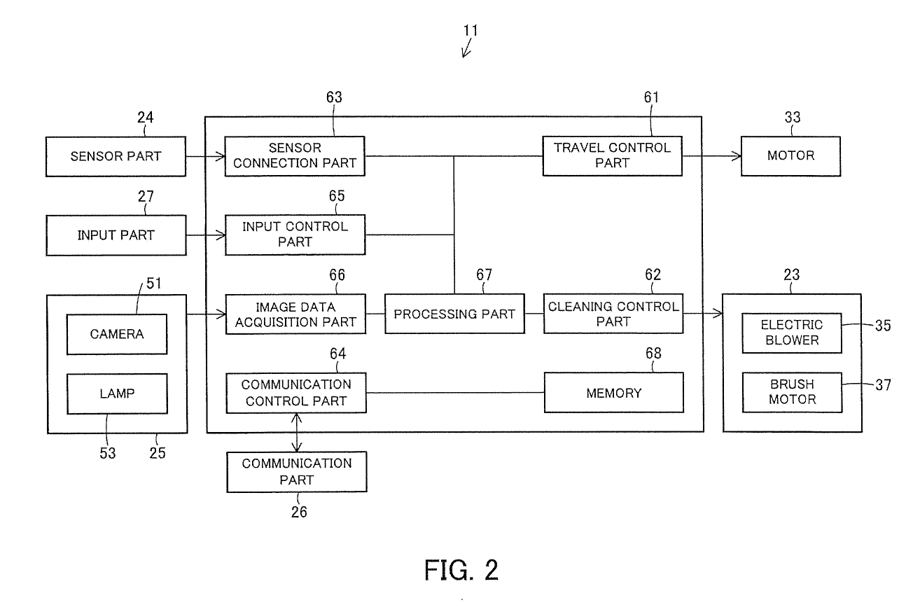

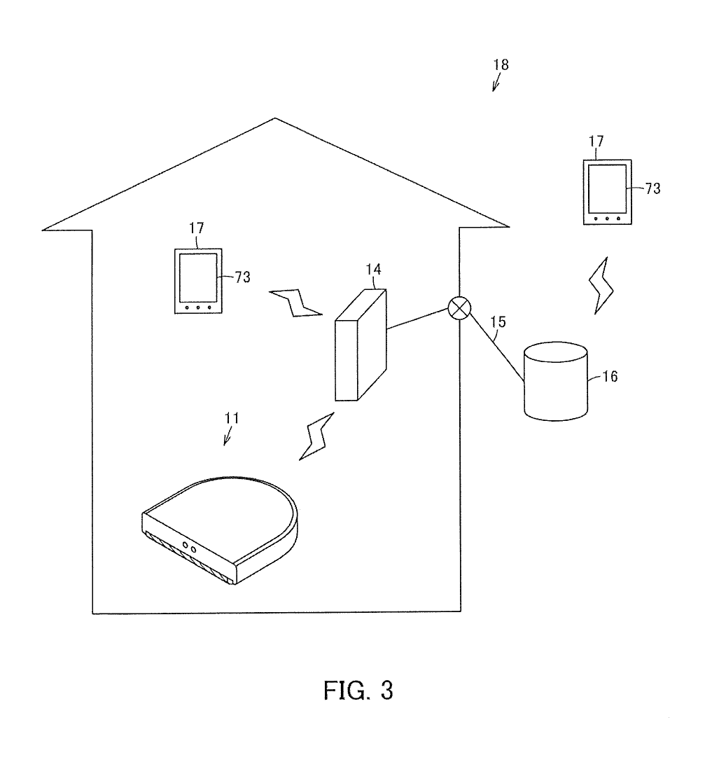

In FIG. 1A, FIG. 1B, FIG. 2, and FIG. 3, reference sign denotes a self-propelled vacuum cleaner. In the specification below, the self-propelled vacuum cleaner 11 is called simply a vacuum cleaner 11. The vacuum cleaner 11 constitutes an electric cleaning device serving as an autonomous traveler device in combination with a charging device or a charging table (not shown) as a station device serving as a base station for charging the vacuum cleaner 11. In the present embodiment, the vacuum cleaner 11 is a so-called self-propelled vacuum cleaner, that is, a robot cleaner or a cleaning robot, which cleans a floor surface that is a cleaning-object surface as a traveling surface, while autonomously traveling or self-traveling on the floor surface. It is noted that the examples of the self-propelled vacuum cleaner 11 include not only a completely autonomously traveling vacuum cleaner, but also a vacuum cleaner capable of self-traveling by being remotely controlled by an external device such as a remote controller. In an example, the vacuum cleaner 11 is capable of performing wired or wireless communication with a general-purpose server 16 serving as data storage means or a general-purpose external device 17 having the function of display means via a network 15 such as the Internet, by performing communication or transmission/reception of data with a home gateway 14 serving as relay means disposed in a cleaning area or the like by using wired communication or wireless communication such as Wi-Fi (registered trademark) or Bluetooth (registered trademark). The vacuum cleaner 11 is also capable of wirelessly communicating with the external device 17 via the home gateway 14, inside a building or in a house, as an example. Accordingly, the vacuum cleaner 11 and the external device 17 constitute a vacuum cleaning system 18, via the home gateway 14, the network 15, the server 16, and the like.

The vacuum cleaner 11 includes a hollow main casing 20 which is the main body capable of self-propelling. The vacuum cleaner 11 further includes driving wheels 21 serving as travel driving parts. The vacuum cleaner 11 may further include a swing wheel 22 serving as an auxiliary wheel. The vacuum cleaner 11 further includes an electric cleaning unit 23 for removing dust and dirt on the floor surface. The vacuum cleaner 11 may further include a sensor part 24. The vacuum cleaner 11 further includes an image capturing part 25. The vacuum cleaner 11 may further include a communication part 26 having the functions of receiving means and transmitting means serving as output means. The vacuum cleaner 11 may further include an input part 27 to which a signal is input by a user. The vacuum cleaner 11 further includes a control unit 28 which is a controller serving as control means. The vacuum cleaner 11 may include a battery for power supply serving as a power source part. It is noted that the following description will be given on the basis that a direction extending along the traveling direction of the vacuum cleaner 11 or the main casing 20 is treated as a back-and-forth direction (directions of an arrow FR and an arrow RR shown in FIG. 1A and other drawings), while a left-and-right direction or directions toward both sides intersecting or orthogonally crossing the back-and-forth direction are treated as widthwise directions.

The main casing 20 has a front face 20a which may be formed into, for example, a planar shape along the left-and-right direction. The main casing 20 further has a suction port 31 or the like serving as a dust-collecting port in the lower part or the like facing the floor surface. The suction port 31 is positioned in the front side of the main casing 20, which corresponds to the foremost portion of the main casing 20 in the present embodiment. That is, the suction port 31 may be formed all over from the front face 20a corresponding to the front portion of the main casing 20 to the lower part thereof. Additionally, the suction port 31 is disposed symmetrically or substantially symmetrically with respect to the center line of the main casing 20 in the left-and-right direction, as an example. The suction port 31 is further formed to have a longitudinal shape in the left-and-right direction, that is, a laterally long shape. In the present embodiment, the central portion in the left-and-right direction of the suction port 31 coincides or substantially coincides with the central portion in the left-and-right direction of the main casing 20. They may be displaced from each other.

The driving wheels 21 are used to make the main casing 20 autonomously travel on the floor surface in the advancing direction and the backward direction, that is, serve for traveling use. In the present embodiment, a pair of the driving wheels 21 is disposed, for example, on the left and right sides of the main casing 20 at positions behind the suction port 31. These driving wheels 21 are independently driven by motors 33 each serving as driving means. It is noted that a crawler or the like may be used as a driving part, instead of these driving wheels 21.

The swing wheel 22 is configured to support the main casing 20 on the floor surface together with the driving wheels 21. The swing wheel 22, which is a driven wheel as an example, is disposed on the lower part of the main casing 20 so as to be rotatable in parallel (including substantially parallel) with the floor surface. In the present embodiment, the swing wheel 22 is positioned in front of the driving wheels 21 and behind the suction port 31, and is positioned in the vicinity of the suction port 31 and at the central portion or substantially central portion in the left-and-right direction on the main casing 20.

The electric cleaning unit 23 is configured to remove dust and dirt on the floor surface, as an example. In an example, the electric cleaning unit 23 has the function of collecting and catching dust and dirt on the floor surface through the suction port 31, and/or the function of wiping a wall surface. The electric cleaning unit 23 includes an electric blower 35 for sucking dust and dirt through the suction port 31. The electric cleaning unit 23 may further include a rotary brush 36 serving as a rotary cleaner rotatably attached to the suction port 31, and a brush motor 37 for rotationally driving the rotary brush 36. Accordingly, the electric cleaning unit 23 is configured to remove dust and dirt on the floor surface facing the front side of the main casing 20, which is the foremost edge of the lower part of the main casing 20 in the present embodiment. The electric cleaning unit 23 is configured to collect dust and dirt into a dust-collecting unit 40 through the suction port 31. In other words, the vacuum cleaner 11 includes the electric blower 35. The vacuum cleaner 11 may further include the rotary brush 36 serving as a rotary cleaner and the brush motor 37 for rotationally driving the rotary brush 36. The vacuum cleaner 11 further includes the dust-collecting unit 40.

The electric blower 35 is configured to suck dust and dirt together with air into the dust-collecting unit 40 by transmitting a negative pressure through the suction port 31 to the floor surface. The electric blower 35 is accommodated in the main casing 20, and the suction side thereof communicates with the suction port 31 via the dust-collecting unit 40. The electric blower 35 is connected to the central portion in the longitudinal direction, which is the central portion of the suction port 31. Therefore, the suction force or the negative pressure at the central portion is the strongest at the suction port 31, and the suction force or the negative pressure at a position closer to each of the both end portions in the longitudinal direction becomes weaker.

The rotary brush 36 is configured to scrape up or scrape out dust and dirt on the floor surface. The rotary brush 36 has a shaft along the longitudinal direction of the suction port 31. In other words, the rotary brush 36 has a shaft along the direction in parallel or substantially parallel with the floor surface, and is disposed so as to rotate in the up-and-down direction.

The sensor part 24 may include, for example, a dust sensor serving as dust-and-dirt amount detection means for detecting the amount of dust and dirt on the floor surface to be collected into the dust-collecting unit 40 through the suction port 31. The sensor part 24 may further include obstacle detection means such as an infrared sensor or an ultrasonic sensor for sensing, for example, a state of pits and bumps of the floor surface or a step gap, or a wall or an obstacle which hinders the traveling of the vacuum cleaner 11.

The image capturing part 25 includes a camera 51 serving as an image-pickup-means main body. The image capturing part 25 may further include a lamp 53 serving as illumination means for illuminating the image range of the camera 51. Accordingly, the vacuum cleaner 11 includes the camera 51 serving as image capturing means. The vacuum cleaner 11 may further include the lamp 53 which is auxiliary detection means serving as illumination means.

The camera 51 is a digital camera for capturing a digital image or a digital video image of the forward area in the traveling direction of the main casing 20. One unit or a plurality of units of the cameras 51 may be provided. In the present embodiment, a pair of the cameras 51 is disposed on the front face 20a of the main casing 20. Each of the cameras 51 includes image capturing elements such as a lens, a diaphragm, a shutter, and a CCD, and an image capturing control circuit, and the like (not shown). The cameras 51 are disposed on the upper portion of the front side of the main casing 20, as an example. In the present embodiment, the cameras 51 are disposed on the upper portion of the front face 20a. Each of the cameras 51 has a view angle allowing it to capture an image of the immediate forward area of the main casing 20, that is, the floor surface immediately in front of the suction port 31 or the rotary brush 36 and the forward area of the main casing 20, as an image range CA. The suction port 31 is disposed in the main casing 20 at a position adjacent to the image ranges CA of the cameras 51. The image range CA of each of the cameras 51 is set so as to include at least the width range of the vacuum cleaner 11 or the main casing 20 in the left-and-right direction. In other words, each of the cameras 51 is set to have a wide angle of view in the left-and-right direction.

The communication part 26 is capable of mutually communicating with an external device 17 that is positioned outside the building via the home gateway 14 and the network 15 through the server 16. The communication part 26 is also capable of mutually communicating with an external device 17 that is positioned inside the building via the home gateway 14. The communication part 26 is capable of transmitting data to the external device 17, and also capable of receiving signals from the external device 17. In an example, the communication part 26 includes a wireless LAN device serving as wireless communication means for wirelessly communicating with the external device 17 and as cleaner signal receiving means, and the like. It is noted that the communication part 26 may have an access point function and perform direct wireless communication with the external device 17 without the home gateway 14, as an example. The communication part 26 may additionally have, for example, a web server function.

The input part 27 may be signal receiving means such as an infrared communication part which receives a control command based on a radio signal, for example, an infrared signal transmitted by an external device such as a remote controller (not shown), or may be a switch, a touch panel, or the like that is disposed on the main casing 20 and through which a control command is input by a user's operation.

For example, a microcomputer including control means main bodies such as a CPU, a ROM, and a RAM is used as the control unit 28. The control unit 28 is electrically connected to the electric cleaning unit 23, the sensor part 24, the image capturing part 25, the communication part 26, and the like. More specifically, the control unit 28 includes a travel control part 61 serving as travel control means. The control unit 28 further includes a cleaning control part 62 serving as output control means. The control unit 28 may further include a sensor connection part 63 serving as sensor control means. The control unit 28 may further include a communication control part 64 serving as communication control means. The control unit 28 may further include an input control part 65 serving as input control means. The control unit 28 further includes an image data acquisition part 66 for acquiring image data from the cameras 51 of the image capturing part 25. The control unit 28 further includes a processing part 67. The control unit 28 further includes a memory 68 serving as storage means. The control unit 28 is further connected to a battery electrically. The control unit 28 may further include a charging control part for controlling charging of the battery.

The travel control part 61 controls the driving of the driving wheels 21 by controlling the driving of the motors 33. The travel control part 61 includes a cleaning mode, in which the travel control part 61 sets a traveling route on the basis of the map data indicating the traveling area or corresponding to the traveling area such as a room where the vacuum cleaner 11 is disposed, and controls the driving of the driving wheels 21 or the motors 33, thereby making the main casing 20 perform cleaning while making the main casing 20 autonomously travel in the traveling area along the traveling route.

The cleaning control part 62 is configured to control the operation of the electric cleaning unit 23. In the present embodiment, the cleaning control part 62 controls the driving of the electric blower 35 and the brush motor 37, thereby controlling the driving of the electric blower 35 and the brush motor 37 or the rotary brush 36.

The sensor connection part 63 is electrically connected to the sensor part 24. The sensor connection part 63 is capable of acquiring the detection result from the sensor part 24 and outputting the detection result to the travel control part 61 and the processing part 67.

The communication control part 64 is electrically connected to the communication part 26. The communication control part 64 is further connected to the processing part electrically. The communication control part 64 is configured to process the signals and data to be transmitted by the communication part 26 and the signals and data received by the communication part 26.

The input control part 65 is electrically connected to the input part 27 or is provided integrally with the input part 27. The input control part 65 is electrically connected to the processing part 67. The input control part 65 is configured to process the control command input by the input part 27.

The image data acquisition part 66 is configured to acquire the images captured by the cameras 51 and output the images to the processing part 67. The image data acquisition part 66 may have the function of image correction means (an image correction part) for performing primary image processing to the data of the original images captured by the cameras 51, such as correction of distortion caused by the lenses of the cameras 51, noise reduction, contrast adjusting, and image-center matching.

The processing part 67 is electrically connected to the sensor connection part 63, the communication control part 64, and the image data acquisition part 66, respectively. The processing part 67 is configured to perform various types of image processing on the basis of the data of the images captured by the cameras 51.

The processing part 67 has the functions of: extracting feature points and the like from the image data of objects captured by the cameras 51 such as a floor surface, a wall, dust and dirt, and the like positioned immediately in front of the main casing 20, that is, immediately in front of, for example, the suction port 31 or the rotary brush 36; comparing the extracted feature points with the feature points corresponding to the feature information which is stored in the memory 68 in advance, and which includes obstacles and types of floor surfaces, dust and dirt corresponding to objects to be removed or objects to be sucked, and objects not to be removed or objects not to be sucked; and detecting whether or not an obstacle exists, the type of the floor surface, whether or not dust and dirt exists, and whether or not an object not to be removed exists, in the area immediately in front of the suction port 31 or the rotary brush 36 within a predetermined distance in the forward area of the main casing 20. The processing part 67 and the cameras 51 are configured to provide the function of obstacle detecting means for detecting an obstacle positioned within a predetermined distance in the forward area of the main casing 20, the function of cleaning-object surface determination means for determining the type of the floor surface, the function of dust and dirt detecting means for detecting whether or not dust and dirt exists, and the function of object-not-to-be-removed detecting means for determining whether or not an object not to be removed exists, respectively.

It is noted that, in an example, the processing part 67 is also capable of roughly calculating a distance between an object and the vacuum cleaner 11 or the main casing 20, on the basis of the position of the object in the image data. The image of the floor surface and the like in the forward area of the main casing 20 is captured as the image range CA of each of the cameras 51. Accordingly, an object positioned at a position relatively closer to the upper side in the image range CA is determined as an object positioned further away from the vacuum cleaner 11 or the main casing 20.

The processing part 67 further has the functions of mapping means and self-position estimation means using the known technology of SLAM (simultaneous localization and mapping) or the like for generating map data of the traveling area or the cleaning-object area and estimating the self-position by extracting feature points from the image data captured by the cameras 51 and processing the feature points in a three-axis coordinate system.

A nonvolatile memory, for example, a flash memory, is used as the memory 68. The memory 68 stores feature points such as of obstacles such as a wall, types of floor surfaces, and dust and dirt corresponding to objects to be removed. In an example, the memory 68 stores feature points such as of flooring, carpet, and tatami as types of floor surfaces. The memory 68 is further capable of storing feature points of objects not to be removed which are not to be removed by the vacuum cleaner 11, for example, an accessory. The memory 68 may further store map data of a traveling-object area created by the processing part 67 or input from the outside.

The battery is configured to supply power to the electric cleaning unit 23, the sensor part 24, the cameras 51 and the lamp 53 of the image capturing part 25, the communication part 26, the control unit 28, and the like. In the present embodiment, for example, a rechargeable secondary battery is used as the battery. Therefore, in the present embodiment, for example, charging terminals 71 for charging the battery are disposed so as to be exposed on the bottom of the main casing 20.

The charging device is the base station to which the vacuum cleaner 11 returns when finishing traveling and cleaning. The charging device may incorporate a charging circuit, for example, a constant current circuit. The charging device is also configured with terminals for charging to be used to charge the battery. The terminals for charging are electrically connected to the charging circuit. The terminals for charging are further configured to be mechanically and electrically connected to the charging terminals 71 of the vacuum cleaner 11 when returning to the charging device.

The home gateway 14, which is also called an access point or the like, is disposed inside a building so as to be connected to the network 15 by, for example, wire.

The server 16, which is a computer or a cloud server connected to the network 15, is capable of storing various types of data.

The external device 17 is a general-purpose device, for example, a PC, a tablet PC, a smartphone, a mobile phone or the like, which is capable of, inside a building, performing wired or wireless communication with the network 15 via, for example, the home gateway 14, and outside a building, performing wired or wireless communication with the network 15. The external device 17, which includes a display 73 such as a liquid crystal display, has the function of display means for at least displaying an image on the display 73. The display 73 may have a touch panel function, as an example. That is, the display 73 has the function of an input part. The external device 17 may further include a camera (not shown). Additionally, the application or the program for registering an object not to be removed in the vacuum cleaner 11 may be installed into the external device 17. Specifically, in registering an object not to be removed, the image captured by, for example, the camera mounted on the external device 17, is able to be registered by use of the above-described application. In an example, as shown in FIG. 8, the captured image of an object A1 not to be removed is displayed on the display 73 of the external device 17. A registration button B displayed on the display 73 is then operated, whereby the image data of the object A1 not to be removed is transmitted from the external device 17 to the vacuum cleaner 11 via the network 15 and the server 16 shown in FIG. 3. When the communication part 26 of the vacuum cleaner 11 shown in FIG. 2 receives the image data, the image data or the feature points extracted from the image data are stored in the memory 68, whereby the registration of the object not to be removed is completed. The external device 17 may further have in advance the function of transmitting and receiving e-mail.

The operation of the above-described embodiment is described below.

The outline from the start to the end of the cleaning to be performed by the vacuum cleaner 11 is described first. The vacuum cleaner 11 undocks from, for example, the charging device, when starting cleaning, and then cleans the floor surface while traveling along a predetermined traveling route, for example, a zigzag traveling route, on the basis of the map data stored in the memory 68. After traveling all over the traveling area, the vacuum cleaner 11 returns to the charging device and finishes the cleaning. After the cleaning is finished, the battery begins to charge at a predetermined timing.

The above control is described more specifically. The control unit 28 is switched into a traveling mode, at a timing such as when a preset cleaning start time arrives or when the communication part 26 or the input part 27 receives the control command to start the cleaning transmitted by the external device 17 or the like, and whereby the vacuum cleaner 11 starts the cleaning. In other words, in the vacuum cleaner 11, the travel control part 61 starts to drive the driving wheels 21 or the motors 33, the cleaning control part 62 starts to drive the electric blower 35 and the rotary brush 36 or the brush motor 37 of the electric cleaning unit 23, and the cameras 51 start to capture images, that is, the image data acquisition part 66 starts to acquire the image data. In the case where the map data of the traveling area is not stored in the memory 68 at this time, the vacuum cleaner 11 performs predetermined behavior such as zigzag traveling so that the obstacle detection means of the sensor part 24, the cameras 51, the processing part 67 and the like detect obstacles and the like around the main casing 20, whereby the processing part 67 is able to generate the map data. It is noted that the lamp 53 is able to provide illumination as needed when the cameras 51 capture images.

The travel control part 61 then generates the traveling route on the basis of the map data. It is noted that in the case where the map data is stored in the memory 68 in advance, the travel control part 61 generates the traveling route on the basis of the map data stored in the memory 68 without generating the map data.

The travel control part 61 then controls the driving wheels 21 or the motors 33 so as to make the main casing 20 autonomously travel along the set traveling route, while the cleaning control part 62 makes the electric cleaning unit 23 operate to clean the floor surface in the traveling area or a cleanable area.

The processing part 67 then extracts the feature points of the floor surface, the wall or the like immediately in front of the main casing 20, that is, immediately in front of, for example, the suction port 31 or the rotary brush 36, on the basis of the image data acquired via the image data acquisition part 66, compares the extracted feature points with the feature points which are stored in advance in the memory 68, and which correspond to obstacles and types of floor surfaces, dust and dirt corresponding to objects to be removed, and objects not to be removed, and detects whether or not an obstacle exists, the type of the floor surface, whether or not dust and dirt exists, and whether or not an object not to be removed exists, in the area immediately in front of the main casing 20, that is, immediately in front of, for example, the suction port 31 or the rotary brush 36, on the basis of matching scores.

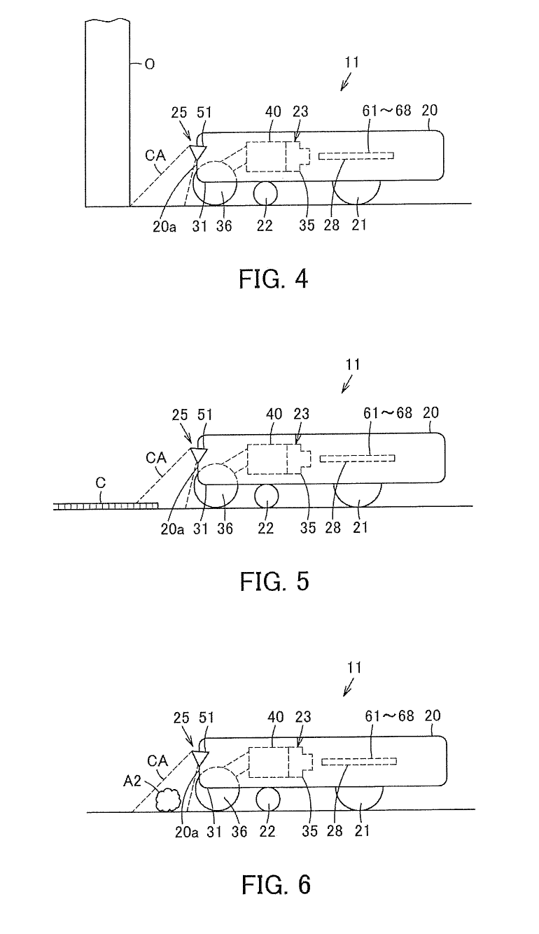

In the case where the type of the floor surface is flooring, as an example, dust and dirt tend to accumulate at a corner in the traveling area such as a wall and in a vicinity of an obstacle. Accordingly, in the case where the processing part 67 determines that the type of the floor surface immediately in front of the main casing 20, that is, immediately in front of, for example, the suction port 31 or the rotary brush 36 is flooring, and when the processing part 67 detects an obstacle O such as a wall within a predetermined distance as shown in FIG. 4, the traveling speed of the main casing 20 is reduced, or the output of the electric cleaning unit 23 is increased, or alternatively both are performed.

In the case where the type of the floor surface is carpet, dust and dirt are difficult to suck compared to the case of flooring. Therefore, as shown in FIG. 5, if the processing part 67 determines that the type of the floor surface immediately in front of the main casing 20, that is, immediately in front of, for example, the suction port 31 or the rotary brush 36 is a carpet C, the traveling speed of the main casing 20 is reduced, or the output of the electric cleaning unit 23 is increased, or alternatively both are performed.

Therefore, when the processing part 67 detects that the type of the floor surface within a predetermined distance is changed on the basis of the image data of the images captured by the cameras 51, the operation of the driving wheels 21 or the motors 33 is controlled to change the traveling speed of the main casing 20.

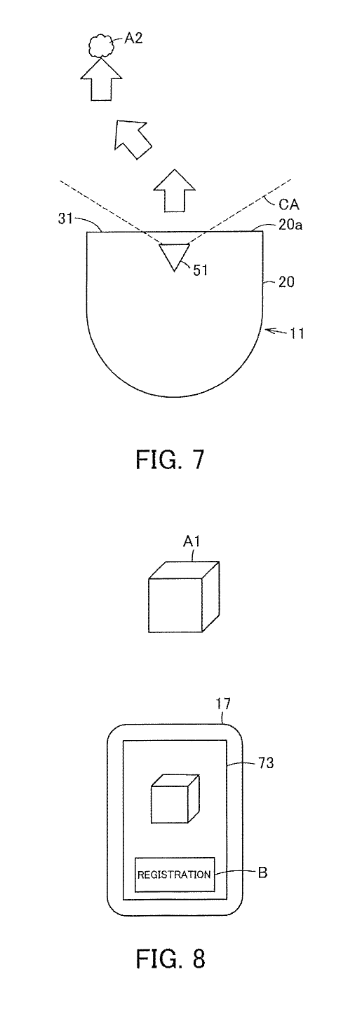

Also in the case where the processing part 67 detects an object A2 to be removed such as cotton dust on the floor surface as shown in FIG. 6, the traveling speed is reduced, or the output of the electric cleaning unit 23 is increased, or alternatively both are performed, similarly. At this time, since the position of the dust and dirt is grasped from the image data of the images captured by the cameras 51, the travel control part 61 controls the operation of the driving wheels 21 or the motors 33, so that the central portion of the suction port 31 passes directly over the object A2 to be removed, as indicated by the arrows shown in FIG. 7.

In the case where the traveling speed of the main casing 20 is reduced as described above, the travel control part 61 reduces the rotational speed of the driving wheels 21 or the motors 33, thereby making the main casing 20 travel in the deceleration condition. The traveling speed in the deceleration condition may be arbitrarily set in accordance with, for example, the type of the floor surface, or may be changed through switching to a predetermined traveling speed or switching to a traveling mode in which the predetermined traveling speed is relatively slow.

In the case where the output of the electric cleaning unit 23 is increased as described above, the cleaning control part 62 increases the output or the suction force of the electric blower 35, or increases the rotational speed of the rotary brush 36, or alternatively performs both.

In any case other than the cases described above, the outputs of the electric blower 35 and the rotary brush 36 of the electric cleaning unit 23 are relatively lowered in order to suppress the consumption of the battery during cleaning, and the traveling speed is set to be relatively fast in order to shorten the cleaning time.

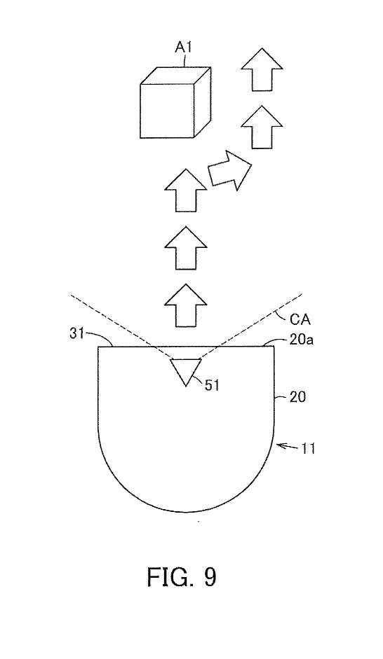

Further, in the case where the processing part 67 determines that the object A1 not to be removed exists on the floor surface in the forward area of the main casing 20 as shown in FIG. 9, a bypassing operation corresponding to an evasive operation is performed as indicated by arrows, or the output of the electric cleaning unit 23 is stopped or reduced, or alternatively both are performed. In the case where the evasive operation is performed, the travel control part 61 controls the operation of the driving wheels 21 or the motors 33, so that the main casing 20 bypasses the object not to be removed, that is, so that the main casing 20 travels along a route avoiding the position of the object A1 not to be removed, which is not to be cleaned by the electric cleaning unit 23. Additionally, in the present embodiment, in the case where the output of the electric cleaning unit 23 is stopped or lowered, the cleaning control part 62 stops or reduces the output or the suction force of the electric blower 35, and stops the rotation or reduces the rotational speed of the rotary brush 36 or the brush motor 37. The cleaning control part 62 may produce such effects even by performing at least one of these operations.

After traveling all over the traveling area and finishing the cleaning, the vacuum cleaner 11 returns to the charging device so as to be connected to the charging device.

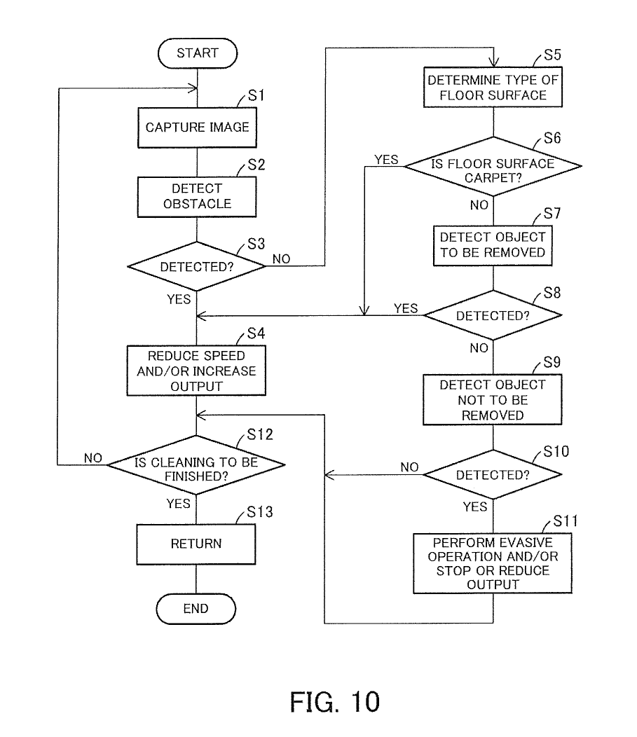

These controls are described with reference to the flowchart shown in FIG. 10.

When the cleaning control is started, first in step S1, the cameras 51 capture images while the travel control part 61 controls the operation of the driving wheels 21 or the motors 33 to make the main casing 20 travel in the traveling area. Then in step S2, the processing of detecting an obstacle is performed, in which the image data acquisition part 66 acquires the image data, and in which the processing part 67 compares the feature points extracted from the image data with the feature points of obstacles stored in the memory 68. Then in step S3, the processing part 67 determines whether or not an obstacle has been detected.

In the case where, in step S3, the processing part 67 determines that an obstacle has been detected, in step S4, the travel control part 61 controls the operation of the driving wheels 21 or the motors 33 to reduce the traveling speed of the main casing 20, and/or the cleaning control part 62 increases the output of the electric cleaning unit 23, and thereafter the processing advances to step S12 to be described below. While in the case where, in step S3, the processing part 67 determines that an obstacle has not been detected, in step S5, the processing part 67 performs the processing of determining the type of floor surface, in which the processing part 67 compares the feature points extracted from the image data with the feature points of the floor surfaces stored in the memory 68. Then in step S6, the processing part 67 determines whether or not the type of the floor surface is carpet.

In the case where, in step S6, the processing part 67 determines that the floor surface is carpet, the processing advances to step S4. On the other hand, in the case where, in step S6, the processing part 67 determines that the floor surface is not carpet, and is flooring as an example, in step S7, the processing part 67 performs the processing of detecting an object to be removed, in which the processing part 67 compares the feature points extracted from the image data with the feature points of objects to be removed stored in the memory 68, for example, large dust and dirt such as cotton dust. Then, in step S8, the processing part 67 determines whether or not an object to be removed has been detected.

In the case where, in step S8, the processing part 67 determines that an object to be removed has been detected, the processing advances to step S4. In this case, the position of the object to be removed may be detected, and the travel control part 61 may control the operation of the driving wheels 21 or the motors 33, so that the central portion of the suction port 31 moves along a traveling route of passing over the object to be removed. While in the case where, in step S8, the processing part 67 determines that an object to be removed has not been detected, in step S9, the processing part 67 performs the processing of detecting an object not to be removed, in which the processing part 67 compares the feature points extracted from the image data with the feature points of objects not to be removed stored in the memory 68. Then, in step S10, the processing part 67 determines whether or not an object not to be removed has been detected.

In the case where, in step S10, the processing part 67 determines that an object not to be removed has been detected, instep S11, the evasive operation is performed, or the output of the electric cleaning unit 23 is stopped or reduced, or alternatively both are performed, and thereafter the processing advances to step S12. While in the case where, in step S10, the processing part 67 determines that an object not to be removed has not been detected, in step S12, the travel control part 61 determines whether to finish the cleaning on the basis of whether or not the traveling has been performed in all over the traveling area.

In the case where, in step S12, the travel control part 61 determines that the cleaning is not to be finished or the traveling has not been performed in all over the traveling area, the processing advances to step S1. While in the case where, in step S12, the travel control part 61 determines that the cleaning is to be finished or the traveling has been performed in all over the traveling area, in step S13, the travel control part 61 operates the driving wheels 21 or the motors 33 to make the main casing 20 return to the charging device, and cleaning control is finished.

According to the embodiment described above, the suction port 31 for collecting dust and dirt is disposed in the main casing 20 at a position adjacent to the image ranges CA of the cameras 51 for capturing images of the forward area of the main casing 20, thereby enabling to perform control according to the surrounding situation.

In other words, if the suction port 31 is disposed at a position away from the image ranges CA of the cameras 51, a considerable time lag may occur until the suction port 31 reaches the image ranges CA during the traveling of the vacuum cleaner 11, which may result in the contents of the control not being adequate to the surrounding situation in some cases. Therefore, the control may be performed by taking into consideration the time lag, on the basis of a prediction in which the suction port 31 reaches the range of the captured image after a period of time corresponding to traveling speed. However, as in the case where the driving wheels 21 idle with respect to the floor surface or in other cases, the traveling may not always be performed as predicted. The configuration as in the present embodiment enables to almost eliminate the time lag until the suction port 31 reaching the image ranges CA of the cameras 51, thereby facilitating the control according to the actual surrounding situation.

When an obstacle is detected within a predetermined distance on the basis of the images captured by the cameras 51, the travel control part 61 controls the operation of the driving wheels 21 or the motors 33 so as to decelerate the main casing 20, thereby enabling to attain careful cleaning in the vicinity of the boundary between the obstacle and the floor surface. It is noted that if the distance between the cameras 51 and an obstacle such as a wall of a room is too short, surrounding information may be difficult to be acquired from the captured images, in some cases. To solve this problem, a distance sensor for detecting a distance between a surrounding object and the vacuum cleaner 11 may be disposed, in addition to the cameras 51. Even in the case where surrounding information is difficult to be acquired from the images captured by the cameras 51, the distance sensor, which is disposed so that the detection range thereof overlaps the image ranges of the cameras 51, is capable of acquiring the surrounding information. Such a distance sensor is available, which detects a distance to a surrounding object by emitting rays of light such as infrared rays or visible rays or ultrasonic waves from the vacuum cleaner 11 to the surroundings and receiving a reflection from a surrounding object. Alternatively, instead of such a distance sensor, a contact sensor may be disposed, which detects contact between the vacuum cleaner 11 and a surrounding object, or such a distance sensor and such a contact sensor may both be disposed. Such a contact sensor is also capable of acquiring surrounding information in the case where the distance between the cameras 51 and an obstacle is too short.

Alternatively, when an obstacle is detected within a predetermined distance on the basis of the images captured by the cameras 51, the cleaning control part 62 increases the output of the electric blower 35 or the rotary brush 36 of the electric cleaning unit 23, thereby enabling to attain careful cleaning in the vicinity of the boundary between the obstacle and the floor surface.

Further, in response to the detection of a change in the type of the floor surface within a predetermined distance based on the images captured by the cameras 51, the travel control part 61 controls the operation of the driving wheels 21 or the motors 33 so as to change the traveling speed of the main casing 20. This enables to suppress elongation of the cleaning time by, while attaining careful cleaning in the case of a floor surface on which dust and dirt are hard to be removed and which requires higher cleaning output, increasing the traveling speed in other cases. In an example, when the vacuum cleaner 11 travels to the position at which the type of the floor surface is changed from flooring to carpet, the traveling speed is reduced so that careful cleaning is performed in the area of the carpet.

Alternatively, in response to the detection of a change in the type of the floor surface within a predetermined distance based on the images captured by the cameras 51, the cleaning control part 62 changes the output of the electric blower 35 or the rotary brush 36 of the electric cleaning unit 23, thereby enabling to perform the cleaning with the cleaning output corresponding to the floor surface. In an example, in the case where the type of the floor surface is flooring, power consumption is reduced, while in the case where the type of the floor surface is carpet, the cleaning output is increased.

Further, in response to the detection of dust and dirt corresponding to an object to be removed on the floor surface based on the images captured by the cameras 51, the travel control part 61 controls the operation of the driving wheels 21 or the motors 33 so as to decelerate the main casing 20. This enables to suppress elongation of the cleaning time by, while facilitating removing of large dust and dirt such as cotton dust detectable from the images captured by the cameras 51, increasing the traveling speed in other cases.

Alternatively, in response to the detection of dust and dirt corresponding to an object to be removed on the floor surface based on the images captured by the cameras 51, the cleaning control part 62 increases the output of the electric blower 35 or the rotary brush 36 of the electric cleaning unit 23. This enables to, while ensuring to remove large dust and dirt such as cotton dust detectable from the images captured by the cameras 51, suppress power consumption in other cases.

Further, in response to the detection of dust and dirt corresponding to an object to be removed on the floor surface based on the images captured by the cameras 51, the travel control part 61 controls the operation of the driving wheels 21 or the motors 33 so that the central portion of the suction port 31 passes directly over the dust and dirt, thereby ensuring to remove the dust and dirt. The negative pressure of the electric blower 35 in particular at the central portion of the suction port 31 is more easily transmitted to the floor surface than that at each of the both end portions of the suction port 31. Therefore, such control reduces the remains of objects to be removed.

In response to the detection of the object not to be removed stored in the memory 68 on the floor surface based on the images captured by the cameras 51, the travel control part 61 controls the operation of the driving wheels 21 or the motors 33 so that the main casing 20 travels while avoiding the object not to be removed. This enables to prevent that the vacuum cleaner 11 removes by mistake the object not to be removed and collects it into the dust-collecting unit 40, by storing in advance such objects not to be removed, for example, an accessory not to be removed, even in the case where a user himself or herself is not present during the cleaning.

Alternatively, in response to the detection of the object not to be removed stored in the memory 68 on the floor surface based on the images captured by the cameras 51, the cleaning control part 62 reduces or stops the output of the electric blower 35 or the rotary brush 36 of the electric cleaning unit 23. This enables to suppress or prevent that the vacuum cleaner 11 collects by mistake the object not to be removed into the dust-collecting unit 40, by storing in advance such objects not to be removed, for example, an accessory not to be removed, even in the case where a user himself or herself is not present during the cleaning.

It is noted that, while the electric cleaning unit 23 is configured to include all of the electric blower 35, the rotary brush 36, and the brush motor 37 in the above-described embodiment, or alternatively the electric cleaning unit 23 may be configured to include only any one of them. In other words, the vacuum cleaner 11 may be configured to suck dust and dirt by applying a negative pressure generated by driving the electric blower 35 through the suction port 31, or may be configured to scrape up dust and dirt by rotationally driving the rotary brush 36 through the dust-collecting port.

In the present embodiment, the vacuum cleaner 11 is configured to include the control to reduce the traveling speed of the main casing 20 and the control to increase the output of the electric cleaning unit 23. Alternatively, the vacuum cleaner 11 may be configured to include only any one of the controls.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A self-propelled vacuum cleaner comprising:
a main body;
a travel driving part configured to make the main body travel;
a travel control part configured to control operation of the travel driving part;
a camera configured to capture an image of a forward area of the main body;
a dust-collecting port disposed in a lower part of the main body; and
an electric cleaning unit configured to collect dust and dirt through the dust-collecting port, wherein
the dust-collecting port is disposed in the main body at a position adjacent to an image range of the camera.

2. The self-propelled vacuum cleaner according to claim 1, wherein
when an obstacle is detected within a predetermined distance on a basis of the image captured by the camera, the travel control part controls the operation of the travel driving part so as to decelerate the main body.

3. The self-propelled vacuum cleaner according to claim 1, wherein
when a change in a type of a cleaning-object surface is detected within a predetermined distance on a basis of the image captured by the camera, the travel control part controls the operation of the travel driving part so as to change a traveling speed of the main body.

4. The self-propelled vacuum cleaner according to claim 1, wherein
when an object to be removed is detected on a cleaning-object surface on a basis of the image captured by the camera, the travel control part controls the operation of the travel driving part so as to decelerate the main body.

5. The self-propelled vacuum cleaner according to claim 1, wherein
when an object to be removed is detected on a cleaning-object surface on a basis of the image captured by the camera, the travel control part controls the operation of the travel driving part so that a central portion of the dust-collecting port passes directly over the object to be removed.

6. The self-propelled vacuum cleaner according to claim 1, the self-propelled vacuum cleaner comprising:
a memory configured to store an object not to be removed, wherein
when an object not to be removed stored in the memory is detected on a cleaning-object surface on a basis of the image captured by the camera, the travel control part controls the operation of the travel driving part so that the main body travels while avoiding the object not to be removed.

7. The self-propelled vacuum cleaner according to claim 1, the self-propelled vacuum cleaner comprising:
an output control part configured to control an output of the electric cleaning unit, wherein
when an obstacle is detected within a predetermined distance on a basis of the image captured by the camera, the output control part increases the output of the electric cleaning unit.

8. The self-propelled vacuum cleaner according to claim 1, the self-propelled vacuum cleaner comprising:
an output control part configured to control an output of the electric cleaning unit, wherein
when a change in a type of a cleaning-object surface is detected within a predetermined distance on a basis of the image captured by the camera, the output control part changes the output of the electric cleaning unit.

9. The self-propelled vacuum cleaner according to claim 1, the self-propelled vacuum cleaner comprising:
an output control part configured to control an output of the electric cleaning unit, wherein
when an object to be removed is detected on a cleaning-object surface on a basis of the image captured by the camera, the output control part increases the output of the electric cleaning unit.

10. The self-propelled vacuum cleaner according to claim 9, the self-propelled vacuum cleaner comprising:
a memory configured to store an object not to be removed, wherein
when the object not to be removed stored in the memory is detected on a cleaning-object surface on a basis of the image captured by the camera, the output control part reduces or stops the output of the electric cleaning unit.
